(19) United States
(12) Patent Application Publication
(10) Pub. No.: US 2019/0070071 A1
(43) Pub. Date: Mar. 7, 2019

(54) IMPRINTED MEDICAL PACKAGES AND METHODS OF MAKING AND USING THE SAME

(71) Applicant: Response Scientific, Inc., Princeton, NJ (US)

(72) Inventor: Gregory Webster, Mooresville, NC (US)

(21) Appl. No.: 16/124,791

(22) Filed: Sep. 7, 2018

Related U.S. Application Data
(60) Provisional application No. 62/555,168, filed on Sep. 7, 2017.

(51) Int. Cl. A61J 1/03; B65B 3/04; B65D 75/30; B65D 75/58; A61J 1/14

(52) U.S. Cl. CPC A61J 1/03; B65B 3/04; A61J 1/14; B65D 75/5805; B65D 75/30

(57) ABSTRACT

The presently disclosed subject matter is generally directed to packages that house one or more pharmaceutical products. The disclosed packages comprise a unique identifier to allow the package contents, prescribing physician, pharmaceutical product lot number, and the like to be tracked. The disclosed packaging system therefore prevents or decreases over-prescription abuse, helps identify and verify patients and physician-prescribers, and tracks and monitors medication prescriptions.

### CROSS REFERENCE TO RELATED APPLICATIONS

This application claims priority to U.S. Provisional Patent Application No. 62/555,168, filed Sep. 7, 2017, which is hereby incorporated by reference in its entirety.

### TECHNICAL FIELD

The presently disclosed subject matter relates to imprinted medical packages and to methods of making and using the disclosed packages.

### BACKGROUND

The illicit use of prescription drugs has become a major concern in the healthcare industry. Particularly, opiates, tranquilizers, stimulants, and sedatives are currently in widespread medical use and have been associated with a dramatic increase in use by drug addicts and recreational drug users. Prescription drugs are often obtained unlawfully through illegal internet shopping, prescription forgery, illegal prescriptions from physicians, and doctor shopping. As a result, the diversion of pain medications is one of the most severe healthcare problems, with the addictive nature of the drugs causing enormous challenges to users and their families. In addition to the immediate risk to the health of patients, the costs of providing health care to patients that become addicted to or otherwise abuse narcotics are, on average, approximately eight times greater than the costs of providing health care to non-abusers. Previous attempts to record and/or monitor the prescription, dispensing, and/or delivery of controlled substances and other prescription medications have proven to be inefficient and ineffective and fail to address widespread doctor-shopping practices that are common. It would therefore be beneficial to provide packaging that enables the tracking of individual prescription medication packages, including information such as dosage, prescribing physician, lot number, and the like.

### SUMMARY

In some embodiments, the presently disclosed subject matter is directed to a package comprising: a first panel constructed from a first packaging material; a second panel constructed from a second packaging material; wherein the first and second panels are sealed together to form a plurality of sealed edges, an interior, and an exterior; wherein the interior is configured to house a product; and wherein the exterior comprises a unique package identifier that identifies the product, product lot number, product manufacture date, prescribing physician, dosage, or combinations thereof. For example, in some embodiments, the identifier identifies the prescribing physician and the associated patient. In some embodiments, the identifier further identifies the product, associated product lot number, associated product manufacture date, product dosage, or combinations thereof.

In some embodiments, the product is a pharmaceutical product, a cosmetic, or a supplement. In some embodiments, the pharmaceutical product is a controlled pharmaceutical product, such as an opioid. In some embodiments, the product is a powder, liquid, gel, hydrogel, or combination thereof.

In some embodiments, the identifier is a 10-digit number. In some embodiments, the identifier is unique for the package.

In some embodiments, the package comprises at least one tear notch. In some embodiments, the tear notch is propagated in a direction parallel with the tear notch.

In some embodiments, the first packaging material, second packaging material, or both comprises a metal foil, wherein the metal foil is selected from aluminum, magnesium, stainless steel, titanium, zinc, nickel, tin, iron, copper, chromium, cobalt, silver, gold, manganese, nickel, alloys thereof, or combinations thereof.

In some embodiments, the first packaging material, second packaging material, or both comprises a polymeric material selected from polyvinyl chloride, polyvinylidene dichloride, polystyrene, ethylene vinyl alcohol, cyclic olefin copolymer, ethylene vinyl acetate, polyethylene, low density polyethylene, very low density polyethylene, polypropylene, polycarbonate, polyethylene terephthalate, polyester, polyamide, polymethylmethacrylate (PMMA), polyetheretherketone), nylon, polylactic acid, or combinations thereof.

In some embodiments, the first packaging material, second packaging material, or both comprises at least one foil layer adhered together with a paper layer, a polymeric layer, or both. In some embodiments, the first packaging material, second packaging material, or both comprises at least one paper layer adhered together with a foil layer, a polymeric layer, or both. In some embodiments, the first packaging material, second packaging material, or both comprises at least one polymeric layer adhered together with a paper layer, a foil layer, or both.

In some embodiments, the disclosed package is sterilizable.

In some embodiments, the disclosed package comprises a product.

In some embodiments, the presently disclosed subject matter is directed to a method of tracking a product, the method comprising packaging the product in a package. The package comprises a first panel constructed from a first packaging material; a second panel constructed from a second packaging material; wherein the first and second panels are sealed together to form a plurality of sealed edges, an interior, and an exterior; wherein the interior is configured to house a product; and wherein the exterior comprises a unique package identifier that identifies the product, product lot number, product manufacture date, prescribing physician, dosage, or combinations thereof; sealing the package to contain the product within the package interior; and tracking the product using the unique identifier.

### BRIEF DESCRIPTION OF THE DRAWINGS

The previous summary and the following detailed descriptions are to be read in view of the drawings, which illustrate some (but not all) embodiments of the presently disclosed subject matter.

FIG. 1a is a perspective view of a package in accordance with some embodiments of the presently disclosed subject matter.

FIG. 1b is a lay flat view of the package of FIG. 1a.

FIGS. 2a and 2b are lay flat views of a package in accordance with some embodiments of the presently disclosed subject matter.

FIG. 3 is a schematic representation of one method of making the disclosed package in accordance with some embodiments of the presently disclosed subject matter.

FIG. 4 is a perspective view of one embodiment of a container housing a plurality of disclosed packages in accordance with some embodiments of the presently disclosed subject matter.

### DETAILED DESCRIPTION

The presently disclosed subject matter is introduced with sufficient details to provide an understanding of one or more particular embodiments of the broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a package” can include a plurality of such packages, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

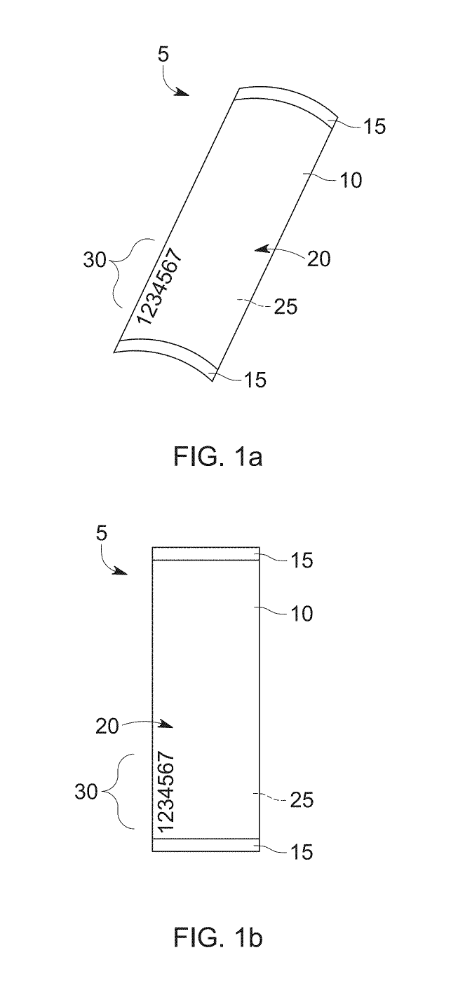

The presently disclosed subject matter is generally directed to packages that are imprinted with a unique identifier to enable tracking and/or identification of the packages, as set forth in more detail herein below. The term “package” as used herein refers to materials configured around a product, and can include one or more bags, pouches, trays, containers, and the like. One example of the disclosed package is illustrated in FIGS. 1a and 1b, showing package 5 comprising body 10 and sealed ends 15. The package comprises interior 20 that is sized and shaped to house product 25. Package 5 further comprises identifier 30 that is used to identify the package contents, product lot number, prescribing physician, etc. The term “identifier” refers to a structural or physical element of a package that is configured to disclose information. The information can include (but is not limited to) one or more letters, numbers, symbols, icons, characters, images, artwork, pattern, logo, design, etc. that act as a unique identifier and/or provide information about a feature of the package.

Package 5 can be constructed from any material known or used in the art, such as one or more of foil, polymeric materials, paper, or combinations thereof. For example, in some embodiments, package 5 can comprise one or more foil materials. The term “foil” as used herein refers to a thin, flexible film or sheet of metal and can include multilayer structures in which at least one layer of metal is adhered to additional layers of other materials. Any metallic material can be used to construct the disclosed foil packaging, such as (but not limited to) aluminium, magnesium, stainless steel, titanium, zinc, nickel, tin, iron, copper, chromium, cobalt, silver, gold, manganese, nickel, alloys thereof, and combinations thereof. In some embodiments, the foil can have a thickness of about 0.1 mil to about 10 mils (e.g., about 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, or 10 mils).

The disclosed foil materials can be constructed using any method known or used in the art, such as refining, smelting, rolling, casting, and/or finishing.

In some embodiments, the disclosed package can be constructed from one or more polymeric materials. The term “polymeric” as used herein refers to products of polymerization reactions, and is inclusive of homopolymers, copolymers, terpolymers, and the like. Suitable polymeric materials can include (but are not limited to) polyvinyl chloride, polyvinylidene dichloride, polystyrene, ethylene vinyl alcohol, cyclic olefin copolymer, ethylene vinyl acetate, polyethylene, low density polyethylene, very low density polyethylene, polypropylene, polycarbonate, polyethylene terephthalate, polyester, polyamide, polymethylmethacrylate, polyetheretherketone, nylon, polylactic acid, and/or copolymers thereof. In some embodiments, the polymeric material can have a thickness of about 1-10 mils (e.g., about 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, or 10 mils).

The disclosed polymeric materials can be constructed using any method known or use in the art. For example, the disclosed polymeric materials can be cast or blown through an annular or flat die, and can be fully coextruded. As used herein, the term “coextruded” refers to the process of extruding two or more materials through a single die with two or more orifices arranged so that the extrudates merge and weld together into a laminar structure before chilling and solidifying. The disclosed polymeric films can be constructed using rotary sealing machines, vertical form-fill and seal equipment, and the like.

In some embodiments, the disclosed package can be constructed from one or more paper materials. The term “paper” as used herein refers to any of the wide variety of known fibrous materials, such as cellulose, cardboard, kraft paper, coated papers, or any other pulp-based materials that are commercially available. In some embodiments, the paper materials can be coated, such as with wax, resin, paraffin, plastic, and the like. The disclosed paper can be of any desired thickness, such as about 1/64 inch to about 1/16 inch.

Thus, in some embodiments, package 5 can comprise at least one foil layer and at least one polymeric and/or paper layer. For example, the metal foil, paper, and/or polymeric film can be adhered together using a sealant layer and/or a tie layer. The term “sealant layer” as used herein refers to a layer, film, sheet, etc. that is capable of being attached to another material, forming a leak-proof seal. Representative sealant layers can include (but are not limited to) ethylene/alpha olefin copolymer, ethylene/vinyl acetate copolymer, ionomer resin, anhydride-modified ethylene/vinyl acetate copolymer, ethylene/acrylic or methacrylic acid copolymer, ethylene/ethylene acrylate copolymer, ethylene/acrylate or methacrylate copolymer, low density polyethylene, anhydride-modified ethylene/α-olefin copolymer, anhydride-modified polyolefin, or combinations thereof. The term “tie layer” as used herein refers to a layer of material that bonds two dissimilar materials and can include (but are not limited to) thermoplastic materials such as ethylene copolymers, polyurethanes, and the like.

In some embodiments, the materials used to construct package 5 can include one or more barrier layers to impart barrier properties to the package. The term “barrier layer” as used herein refers to a layer comprising materials that will control the oxygen and/or moisture permeability of the package. In some embodiments, the package materials can have an oxygen permeability or transmission rate of less than about 20 cm³/m² for a 24-hour period at 1 atmosphere, 0% relative humidity and 23° C., measured in accordance with ASTM D-3985-81. In some embodiments, package 5 can have a moisture barrier transmission rate of about 0.5 g/100 in²/day or less, measured in accordance with ASTM E96B. Suitable oxygen and/or moisture barrier materials can include (but are not limited to) metal foils, ethylene/vinyl alcohol copolymer, polyvinyl chloride, polyvinylidene chloride, polyamide, polyester, polyacrylonitrile, copolymers of vinylidene chloride and vinyl chloride or alkyl acrylate, elastomer, or a blend thereof.

In some embodiments, the materials used to construct package 5 can include one or more abuse layers that serve to resist abrasion, puncture, and other potential causes of reduction in package integrity and package appearance quality. Suitable abuse materials can include (but are not limited to) nylon, metal foils, ethylene alpha/olefin copolymer, ionomer, ethylene/vinyl acetate, and combinations thereof. Optionally, the disclosed packaging materials can be irradiated to cause crosslinking of at least one polymeric layer to improve the abuse and/or puncture resistance and other physical characteristics. Crosslinking is the predominant reaction that occurs on irradiation of many polymers and results in the formation of carbon-carbon bonds between polymer chains. Crosslinking can be accomplished, for example, by irradiation using high energy electrons, gamma-rays, beta particles and the like. In some embodiments, the packaging materials can be irradiated at a level of from 2-12 MRads.

In some embodiments, the disclosed packaging materials have a thickness of about 10-100 μm, such as about 15-90, 20-80, 25-70, 30-60, or 35-50 μm. However, it should be appreciated that thinner or thicker materials can be used and are included within the scope of the presently disclosed subject matter.

In some embodiments, the disclosed package can be formed from one continuous portion of material sealed at one or more ends 15. Alternatively, the package can be constructed from two or more portions of material sealed together at one or more seams. The term “sealed” includes any and all means of closing the package, such as heat sealing via hot air and/or heated bar, ultrasonic sealing, adhesives, and the like.

As illustrated in FIGS. 1a and 1b, the disclosed package comprises one or more sealed ends 15 that create interior 20 for housing product 25. Ends 15 can be sealed using any method known or used in the art, such as by heating a first region of a surface to a second region of a surface. Alternatively or in addition, ends 15 can be sealed using any of a wide variety of adhesives known or used in the art. In some embodiments, the adhesive can be a food-safe adhesive. Alternatively or in addition, ends 15 can be sealed using crimping or other known methods. For example, crimping can be done by stamping or rolling to join two portions of material together by deforming or waging one or both to hold the other. Thus, the package seals can be made using any suitable method known to those skilled in the art, such as heating sealing or the application of cold or hot melt adhesives, a heated bar, hot air, hot wire, infrared radiation, ultrasonic sealing, radio frequency sealing, laser sealing, and the like.

In some embodiments, the package is hermetically sealed. The term “hermetically sealed” refers to a package that is sealed in a manner such that liquids and/or gases located outside the package are prevented from entering the interior of the container, at least to some degree.

Package 5 can be constructed in any of a wide variety of shapes, such as square, rectangular, triangular, cylindrical, oval, tubular, pillowed, trapezoidal, circular, and abstract designs. For example, in some embodiments, container 5 can be shaped as an elongated cylinder, such as the straw-shaped design shown in FIGS. 1a and 1b (e.g., with a round or oval cross-sectional shape). The disclosed package can be configured in any desired size, depending on the product to be packaged. For example, in some embodiments, the package can be about ⅓ inch in diameter and about 2-3 inches in length.

In some embodiments, package 5 can be of any desired stiffness required by the packaged contents. For example, in some embodiments, the package can be flexible or substantially flexible. The term “flexible” as used herein refers to the ability to bend relatively easily and/or the ability to withstand stress and strain without being damaged or broken with a modulus of less than about 50,000 PSI (ASTM D-882-81). However, in some embodiments package 5 can be rigid or substantially rigid. The term “rigid” as used herein refers to materials that have a high stiffness or modulus of elasticity. It should be appreciated that the level of flexibility of package 5 can be customized depending on the particular product to be packaged.

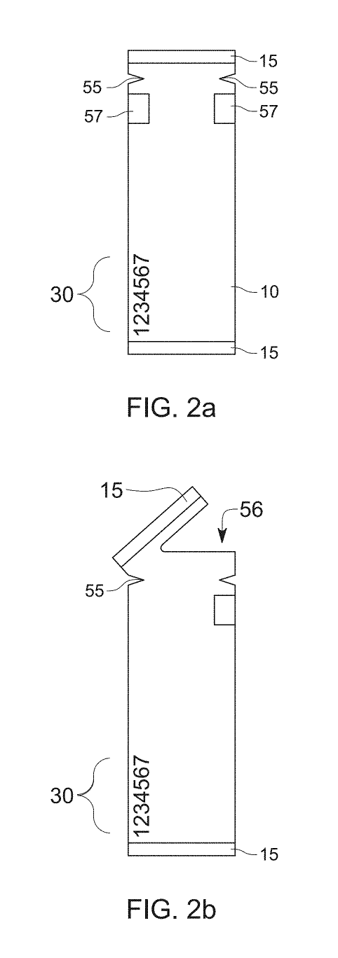

Optionally, package 5 can include one or more opening mechanism (such as tear notches) to facilitate opening of the package to gain access to the package contents. For example, as shown in FIG. 2a, tear notch 55 can be positioned proximal to one end or edge of the package, adjacent to sealed end 15. In some embodiments one, two, or more tear notches can be provided on opposite sides of the package. Tear notch 55 can be formed using any method known in the art, such as (but not limited to) laser material removal, mechanical piercing, and the like. In use, the user applies a separation force in the vicinity of notch 55 to initiate a tear in the package that is meant to be propagated along a certain distance to create opening 56 by which the package contents can be accessed. In some embodiments, the tear is generally created through the entire structure. In some embodiments, the tear direction is parallel to at least one end seal, as shown in FIG. 2b. However, the rear direction is not limited and can be perpendicular to the end seals, or in any desired direction. In some embodiments, the disclosed packaging can include one or more anti-slip ridges 57 positioned adjacent to the tear notch to assist the user when gripping the package to use the tear notch.

Any of a wide variety of products can be packaged within package 5. In some embodiments, product 25 can comprise a pharmaceutical product (such as a medication), a supplement, or a cosmetic. The term “medication” refers to any health-related product that is generally taken on a routine or as-needed basis, such as prescription medicine or other pharmaceutical products. The term “cosmetic” refers to substances that aid in the enhancement or protection of the appearance (e.g., color, texture, look, feel) or odor of the skin. The term “supplement” refers to refers to a composition comprising one or more vitamins, alkaloids, herbs, minerals, fatty acids, lipids, phospholipids, amino acids, herbs and/or other botanicals, enzymes, metabolites, or combinations thereof.

In some embodiments, the medication can be a controlled medication, such as those with a high potential for abuse. Examples of controlled medications include (but are not limited to) methadone, oxycodone, fentanyl, morphine, opium, codeine, hydrocodone, and the like. In some embodiments, the controlled medication can be an opioid. The controlled medication can include one or more substances selected from Schedule I, II, III/IIIN, IV, or V controlled substances as published in Title 21 C.F.R. sections 1308.11 through 1308.15, incorporated by reference herein.

It should be appreciated that product 25 is not limited and can include one or more powders, liquids, gels, hydrogels, and the like, as would be known to those of ordinary skill in the art. The products can be administered by any known method, such as parenteral or enteral (e.g., oral, gastric, subgastric) and thus can be formulated as pills, salves, creams, powders, ointments, capsules, injectable medications, drops, suppositories, etc.

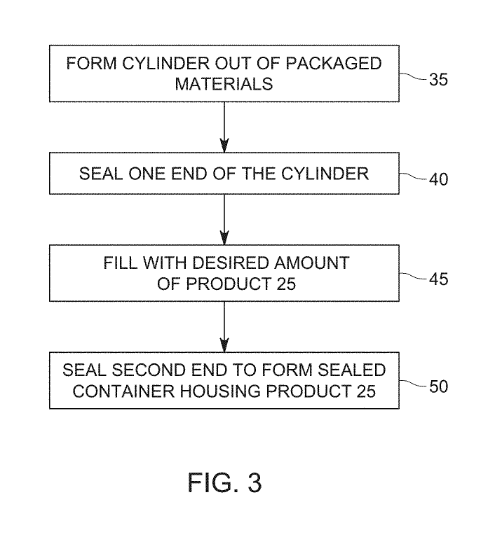

FIG. 3 illustrates one method of forming a sealed package, such as the type illustrated in FIGS. 1a and 1b. Particularly, in step 35 the foil and/or polymeric materials used to form package 5 can be shaped and sealed into a desired form, such as a cylinder that is open on both ends. One end of the package is then dosed (e.g., in the package of FIG. 1a, one end of the cylinder is sealed) using heat sealing methods, adhesive, mechanical closures, and the like as indicated in step 40. The package then includes interior space 20 to house product 25 and one open end through which product 25 enters the interior of the package, as recited in step 45. After a desired amount/dosage of product 25 has been positioned within the package interior, the open package end is then sealed to form a closed container housing product 25, as shown in step 50. In some embodiments, a single dosage can be deposited into the interior of the package. However, the presently disclosed subject matter is not limited and more than one doses can be included. It should be appreciated that the steps of FIG. 3 can be applied to containers of varying shapes and are not limited to cylindrically shaped packages.

In some embodiments, package 5 can be sterilizable. The term “sterilizable” as used herein refers to the ability of the package to be exposed to conditions to reduce the microorganism count to acceptable limits. Suitable sterilization techniques can include (but are not limited to) steam sterilization, ethylene oxide gas sterilization, formaldehyde sterilization, plasma sterilization, and/or ozone sterilization processes.

As set forth herein above, package 5 comprises identifier 30 that can be used to convey information about the package contents. In some embodiments, identifier 30 includes a plurality of numbers and/or letters imprinted or printed directly on the package materials. For example, in some embodiments, the identifier can comprise a unique 7, 8, 9, 10, 11, 12, 13, 14, 15, 16, 17, 18, 19, or 20-digit combination of letters and/or numbers. It should be appreciated that more or less numbers/letters can be used. The identifier can be imprinted directly on one or more surfaces of the disclosed package. The term “imprinting” as used herein refers to stamping by application of pressure or through the use of a laser or to a significant depth inside the host material using machining or laser inscribing techniques as would be known in the art. Advantageously, identifier 30 can be embossed or imprinted on the package and cannot be easily altered. In some embodiments, identifier 30 can be indelible (e.g., cannot be removed).

Visual indicator 30 provides information such as one or more of the prescribing doctor, patient name/address/identifying information, identification of the pharmaceutical, lot number of the pharmaceutical, manufacturing date code, strength of the pharmaceutical, dosage of the pharmaceutical, manufacturer, expiration date, date the prescription was filled, date of previous prescriptions, and the like. Thus, each package 5 includes a unique identifier 30 that allows information about the package to be tracked. In some embodiments, some or all of the identifier is imprinted at the time the package is filled, since all the information may not be known prior to filling (e.g., prescribing doctor). The identifier can be “read” at the point of sale or at the point of dispensing in conjunction with an authentication process. A database can maintain a historical record of packages scanned for the purposes of allowing subsequent review. Such a record can be useful to verify that a package was dispensed, check for authenticity, and to flag any excessive or multiple prescription information (e.g., in situations where a patient has multiple prescriptions from multiple doctors). In some embodiments, the identifier can be scanned using commercially available scanners, saving time and increasing data accuracy. In this way, information can be tracked by regulatory agencies (FDA and/or DEA), doctors, pharmacists, and the like to prevent pharmacy hopping, track medical professionals that prescribe medications, and/or to monitor over prescribing by medical professionals.

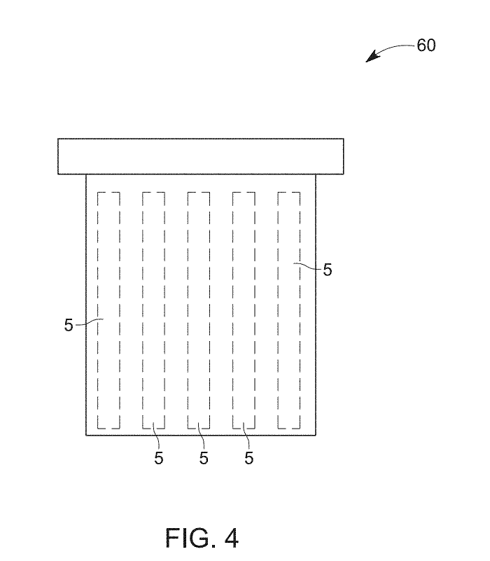

As shown in FIG. 4, a plurality of packages 5 can be assembled together within outer container 60 to position a desired number of medication doses together. For example, container 60 can include 10 packages 5, wherein each package is one dose of product 25. Any desired number of packages can be assembled within container 60, such as (but not limited to) 10, 15, 20, or 25 packages. Container 60 can include any packaging element known or used in the art, such as bottles, boxes, and the like. The container can be labelled (such as by the pharmacist) with corresponding patient information, drug information, date filled, dosage instructions, and the like. When it is time to take the medication, one package can be removed from container 60 by the patient or caregiver and dispensed.

Advantageously, the disclosed packaging system therefore prevents or decreases over-prescription abuse, helps identify and verify patients and physician-prescribers, and tracks and monitors medication prescriptions. The disclosed system can also be used to identify physicians, pharmacists and others authorized to prescribe or dispense medications. When this is done, fraudulent prescriptions can be detected, and physicians, pharmacists, or others who may be obtaining drugs for unauthorized purposes can be identified, and their activities monitored. The technology further serves as a disincentive for practitioners that overprescribe prescription medications, such as opioids or other addictive medications. In this way, problems related with current pharmaceutical quality control can be decreased.

What is claimed is:

1. A package comprising:
a first panel constructed from a first packaging material;
a second panel constructed from a second packaging material;
wherein the first and second panels are sealed together to form a plurality of sealed edges, an interior, and an exterior;
wherein the interior is configured to house a product; and
wherein the exterior comprises a unique package identifier that identifies a prescribing physician and an associated patient.

2. The package of claim 1, wherein the identifier further identifies the product, an associated product lot number, an associated product manufacture date, a product dosage, or combinations thereof.

3. The package of claim 1, wherein the product is a pharmaceutical product, cosmetic, or supplement.

4. The package of claim 3, wherein the pharmaceutical product is a controlled pharmaceutical product.

5. The package of claim 4, wherein the controlled pharmaceutical product is an opioid.

6. The package of claim 1, wherein the product is a powder, liquid, gel, hydrogel, or combination thereof.

7. The package of claim 1, wherein the identifier is a 10-digit number.

8. The package of claim 1, wherein the identifier is unique for the package.

9. The package of claim 1, wherein the first packaging material, second packaging material, or both comprises at least one foil layer adhered to at least one polymeric layer, paper layer, or both.

10. The package of claim 1, wherein the package is sterilizable.

11. The package of claim 1, further comprising a product.

12. A method of tracking a product, said method comprising:
packaging the product in a package comprising:
a first panel constructed from a first packaging material;
a second panel constructed from a second packaging material;
wherein the first and second panels are sealed together to form a plurality of sealed edges, an interior, and an exterior;
wherein the interior is configured to house a product; and
wherein the exterior comprises a unique package identifier that identifies a prescribing physician and an associated patient;
sealing the package to contain the product within the package interior;
tracking the product using the unique identifier.

13. The method of claim 12, wherein the identifier further identifies the product, an associated product lot number, an associated product manufacture date, a product dosage, or combinations thereof.

14. The method of claim 12, wherein the product is a pharmaceutical product, cosmetic, or supplement.

15. The method of claim 14, wherein the pharmaceutical product is a controlled pharmaceutical product.

16. The method of claim 15, wherein the controlled pharmaceutical product is an opioid.

17. The method of claim 12, wherein the identifier is a 10-digit number.

18. The method of claim 12, wherein the identifier is unique for the package.

19. The method of claim 12, wherein the first packaging material, second packaging material, or both comprises at least one foil layer and at least one polymeric layer adhered together.

20. The method of claim 12, wherein the package is sterilizable.
